(19) United States
(12) Patent Application Publication
(10) Pub. No.: US 2022/0036485 A1
(43) Pub. Date: Feb. 3, 2022

(54) INFORMATION PROVIDING APPARATUS, INFORMATION PROVIDING SYSTEM, NON-TRANSITORY COMPUTER READABLE MEDIUM, AND INFORMATION PROVIDING METHOD

(71) Applicant: Toyota Jidosha Kabushiki Kaisha, Toyota-shi Aichi-ken (JP)

(72) Inventors: Tae Sugimura, Miyoshi-shi Aichi-ken (JP); Kenta Miyahara, Toyota-shi Aichi-ken (JP); Shin Sakurada, Toyota-shi Aichi-ken (JP); Tim Wang, Nagoya-shi Aichi-ken (JP)

(21) Appl. No.: 17/388,713

(22) Filed: Jul. 29, 2021

(30) Foreign Application Priority Data
Aug. 3, 2020 (JP) 2020-132049

(51) Int. Cl. G06Q 50/14; G06Q 30/06; G06Q 10/02; G01S 19/01

(52) U.S. Cl. CPC G06Q 50/14; G01S 19/01; G06Q 10/02; G06Q 30/0631

(57) ABSTRACT

An information providing apparatus includes: a communication interface configured to communicate with a terminal apparatus; and a controller configured to: select either one of a food-serving facility and an accommodation facility as a facility to be recommended to a user, according to an arrival time slot in which the user is to arrive at a destination; refer to, when selecting a food-serving facility, first profile data indicating preference of the user for food to select at least one of a plurality of food-serving facility candidates; refer to, when selecting an accommodation facility, second profile data indicating preference of the user for accommodation services to select at least one of a plurality of accommodation facility candidates; and transmit, regardless of which of a food-serving facility and an accommodation facility has been selected, facility data indicating a selected candidate, to the terminal apparatus via the communication interface.

### CROSS-REFERENCE TO RELATED APPLICATION

This application claims priority to Japanese Patent Application No. 2020-132049, filed on Aug. 3, 2020, the entire contents of which are incorporated herein by reference.

### TECHNICAL FIELD

The present disclosure relates to an information providing apparatus, an information providing system, an information providing program, and an information providing method.

### BACKGROUND

Patent Literature (PTL) 1 describes technology for estimating, based on locations of recommended facilities determined based on a preference of a user of a vehicle, an easy-to-find recommended facility that can easily catch an eye of a passenger of the vehicle, and searching for a recommended route using the estimated easy-to-find recommended facility as a target point for any of a waypoint and a destination.

### CITATION LIST

### Patent Literature

PTL 1: JP 2014-098587 A

### SUMMARY

According to the technology described in PTL 1, a facility to be recommended to the user cannot be selected in accordance with the situation under which the user arrives at the destination.

It would be helpful to select a facility to be recommended to the user in accordance with the situation under which the user arrives at the destination.

An information providing apparatus according to the present disclosure includes:
a communication interface configured to communicate with a terminal apparatus; and
a controller configured to:
   select either one of a food-serving facility and an accommodation facility as a facility to be recommended to a user, according to an arrival time slot in which the user is to arrive at a destination; refer to, when selecting a food-serving facility, first profile data indicating preference of the user for food to select at least one of a plurality of food-serving facility candidates; and refer to, when selecting an accommodation facility, second profile data indicating preference of the user for accommodation services to select at least one of a plurality of accommodation facility candidates; and
   transmit, regardless of which of a food-serving facility and an accommodation facility has been selected, facility data indicating a selected candidate, to the terminal apparatus via the communication interface.

An information providing program according to the present disclosure causes a computer to execute operations, the operations including:
receiving, from a terminal apparatus that has accepted an operation made by a user to select a destination, data indicating the destination;
selecting either one of a food-serving facility and an accommodation facility as a facility to be recommended to the user, according to an arrival time slot in which the user is to arrive at the destination; referring to, when selecting a food-serving facility, first profile data indicating preference of the user for food to select at least one of a plurality of food-serving facility candidates; and referring to, when selecting an accommodation facility, second profile data indicating preference of the user for accommodation services to select at least one of a plurality of accommodation facility candidates; and
transmitting, regardless of which of a food-serving facility and an accommodation facility has been selected, facility data indicating a selected candidate, to the terminal apparatus.

An information providing method according to the present disclosure, comprises:
accepting, by the terminal apparatus, an operation made by a user to input a destination;
transmitting, by the terminal apparatus, destination data indicating the destination input by the user to an information providing apparatus;
selecting, by the information providing apparatus, either one of a food-serving facility and an accommodation facility as a facility to be recommended to the user, according to an arrival time slot in which the user is to arrive at a destination; referring to, when selecting a food-serving facility, first profile data indicating preference of the user for food to select at least one of a plurality of food-serving facility candidates; and referring to, when selecting an accommodation facility, second profile data indicating preference of the user for accommodation services to select at least one of a plurality of accommodation facility candidates;
transmitting, regardless of which of a food-serving facility and an accommodation facility has been selected, facility data indicating the facility selected, to the terminal apparatus;
receiving, by the terminal apparatus, the facility data from the information providing apparatus; and
presenting, by the terminal apparatus, the facility data to the user.

The present disclosure enables to select a facility to be recommended to the user in accordance with the situation under which the user arrives at the destination.

### BRIEF DESCRIPTION OF THE DRAWINGS

In the accompanying drawings:

FIG. 1 is a diagram illustrating a configuration of an information providing system according to an embodiment of the present disclosure;

FIG. 2 is a block diagram illustrating a configuration of an information providing apparatus according to an embodiment of the present disclosure;

FIG. 3 is a block diagram illustrating a configuration of a terminal apparatus according to an embodiment of the present disclosure; and
FIG. 4 is a flowchart illustrating an operation of an information providing system according to an embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified, as appropriate.

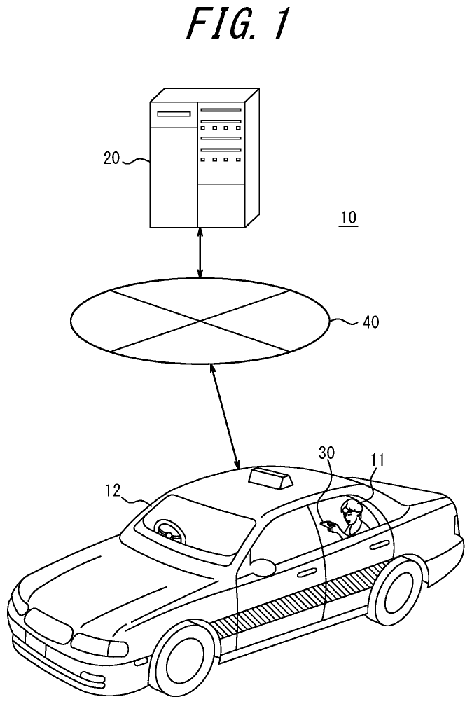

A configuration of the information providing system 10 according to the present embodiment will be described with reference to FIG. 1.

The information providing system 10 includes at least one information providing apparatus 20, and at least one terminal apparatus 30.

The information providing apparatus 20 can communicate with the terminal apparatus 30 via the network 40.

The network 40 includes the Internet, at least one WAN, at least one MAN, or a combination thereof. The term “WAN” is an abbreviation of wide area network. The term “MAN” is an abbreviation of metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The information providing apparatus 20 is located in a facility such as a data center. The information providing apparatus 20 is, for example, a server that belongs to a crowd computing system or another computing system.

The terminal apparatus 30, which is held by the user 11 in the present embodiment, may be mounted or installed in a vehicle 12. That is, the terminal apparatus 30 may be included in the vehicle 12. Examples of the terminal apparatus 30 include a mobile apparatus such as a mobile phone, a smartphone, or a tablet, and a PC. The term “PC” is an abbreviation of personal computer. The terminal apparatus 30 may be an in-vehicle device such as a car navigation device, when included in the vehicle 12.

The vehicle 12 may be a private vehicle, but is operated as a taxi or on-demand bus that delivers the user 11 to the destination in the present embodiment. The vehicle 12 is, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 12 is driven by a driver in the present embodiment, but the driving may be automated at any level. The automation level is, for example, any one of Level 1 to Level 5 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

In the present embodiment, the user 11 includes one user, but may include two or more users. When the vehicle 12 is a private vehicle, the user 11 may be a driver of the vehicle 12.

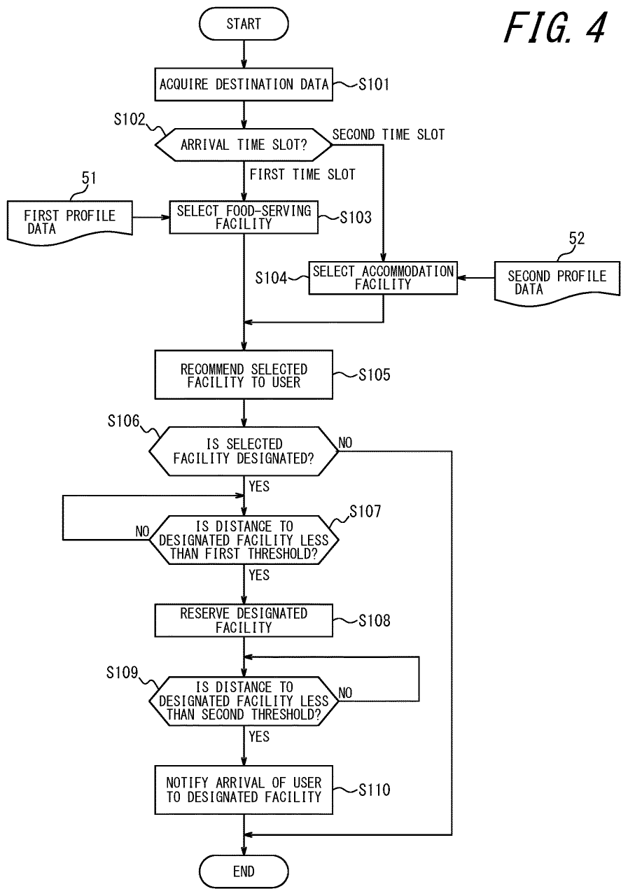

An outline of the present embodiment will be described with reference to FIGS. 1 and 4.

In the information providing system 10 according to the present embodiment, the terminal apparatus 30 accepts an operation made by the user 11 to select a destination. The terminal apparatus 30 transmits data indicating the destination selected by the user 11 to the information providing apparatus 20. The information providing apparatus 20 selects either one of a food-serving facility and an accommodation facility as a facility to be recommended to the user 11, according to an arrival time slot in which the user 11 is to arrive at the destination. When selecting a food-serving facility, the information providing apparatus 20 refers to first profile data 51 indicating the preference of the user 11 for food and selects at least one of a plurality of food-serving facility candidates. When selecting an accommodation facility, the information providing apparatus 20 refers to second profile data 52 indicating the preference of the user 11 for accommodation services and selects at least one of the plurality of accommodation facility candidates. The information providing apparatus 20 transmits facility data indicating the selected candidate to the terminal apparatus 30, regardless of which of a food-serving facility and an accommodation facility has been selected. The terminal apparatus 30 receives the facility data from the information providing apparatus 20. The terminal apparatus 30 presents the facility data to the user 11.

The present embodiment enables to automatically recommend either one of a food-serving facility and an accommodation facility to the user 11, depending on the arrival time slot in which the user 11 is to arrive at the destination.

The “destination” refers to a specific location or area where the user 11 plans to visit. Specific examples for the “destination” include recreational areas such as nature parks, amusement parks, zoos, aquariums, and athletic facilities, and tourist attractions such as ruins, temples, shrines, or hot spring villages.

The “plurality of candidates” include two or more facilities existing in or around the destination, which serve as candidates to be recommended by the information providing apparatus 20 to the user 11. Specific examples for the “food-serving facility candidates” include Italian restaurants, French restaurants, Japanese restaurants, and fast-food restaurants. Specific examples for the “accommodation facility candidates” include hotels, inns, and private accommodations.

The present embodiment assumes that the destination of the user 11 is a nature park. When the time slot during which the user 11 is to arrive at the nature park as the destination is an early time slot of a day or a daytime time slot, it is expected that the user 11 will want to have a meal. Thus, two or more food-serving facilities existing in or around the nature park will be the plurality of candidates. From among the plurality of food-serving facility candidates, at least one facility that matches the preferences of the user 11 is recommended to the user 11. When the arrival time slot during which the user 11 arrives at the nature park as the destination is a late time slot of a day or a nighttime slot, it is expected that the user 11 wants to take a rest. Thus, two or more accommodation facilities existing in the nature park or in the vicinity of the nature park will be the plurality of candidates. From among the plurality of accommodation facility candidates, at least one accommodation facility that matches the preference of the user 11 is recommended to the user 11.

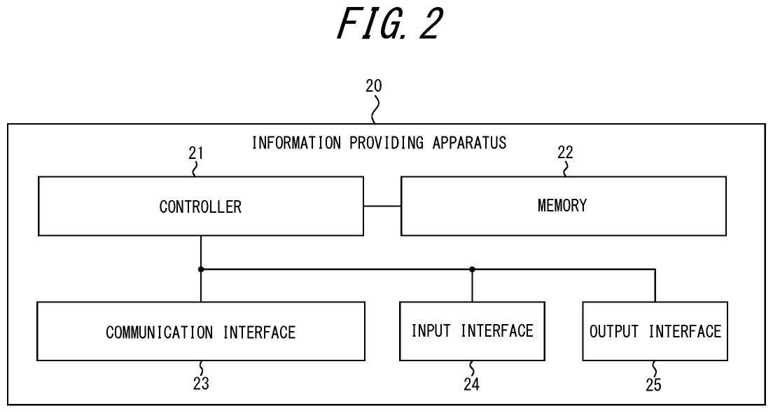

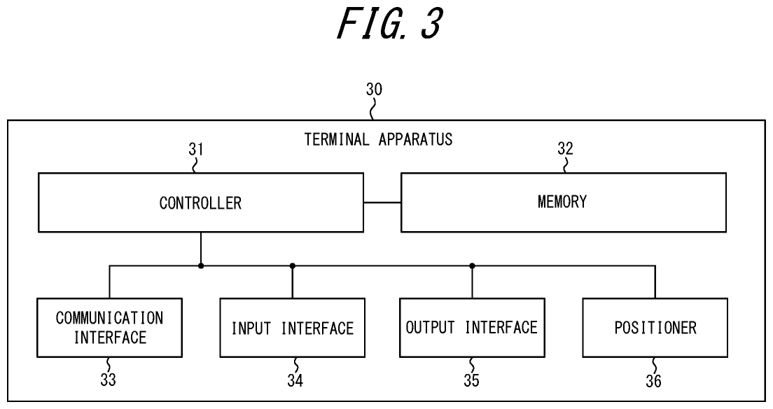

A configuration of the information providing apparatus 20 according to the present embodiment will be described with reference to FIG. 2.

The information providing apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuitry is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processing related to the operation of the information providing apparatus 20 while controlling each component of the information providing apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data for use in an operation of the information providing apparatus 20 and data obtained by an operation of the information providing apparatus 20.

The communication interface 23 includes at least one interface for communication. The interface for communication is, for example, a LAN interface. The communication interface 23 receives data for use in an operation of the information providing apparatus 20, and transmits data obtained by an operation of the information providing apparatus 20.

The input interface 24 includes at least one interface for input. The interface for input is, for example, a physical key, a capacitive key, a pointing device, a touch screen integrally provided with a display, or a microphone. The input interface 24 accepts an operation to input data for use in an operation of the information providing apparatus 20. The input interface 24, instead of being included in the information providing apparatus 20, may be connected to the information providing apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by an operation of the information providing apparatus 20. The output interface 25, instead of being included in the information providing apparatus 20, may be connected to the information providing apparatus 20 as an external output device. As the connection method, any technology such as USB, HDMI®, or Bluetooth® can be used.

The functions of the information providing apparatus 20 are realized by executing the information processing program according to the present embodiment by a processor as the controller 21. That is, the functions of the information providing apparatus 20 are realized by software. The information processing program causes the computer to function as the information providing apparatus 20 by causing the computer to execute operations of the information providing apparatus 20. That is, the computer functions as the information providing apparatus 20 by executing the operations of the information providing apparatus 20 in accordance with the information processing program.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processing in accordance with the read program using the processor. The computer may read a program directly from the portable medium and execute processing according to the program. The computer may execute processing according to the received program in order each time a program is transferred from a predetermined server to the computer. The processing may be executed through a so-called ASP-type service which implements functions merely by execution of instructions and acquisition of results, without transferring the program from the predetermined server to the computer. The term “ASP” is an abbreviation of application service provider. Programs encompass information for use in processing by a computer, equivalent to a program. For example, data which is not a direct instruction to a computer but has properties that define the processing of the computer corresponds to the “information equivalent to a program” in this context.

Some or all of the functions of the information providing apparatus 20 may be realized by a programmable circuit or a dedicated circuit as the controller 21. That is, some or all of the functions of the information providing apparatus 20 may be realized by hardware.

A configuration of the terminal apparatus 30 according to the disclosed embodiment is explained with reference to FIG. 3.

The terminal apparatus 30 includes: a controller 31; a memory 32; a communication interface 33; an input interface 34; an output interface 35; and a positioner 36.

The controller 31 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 controls each component of the terminal apparatus 30 to execute processing related to the operations of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data for use in an operation of the terminal apparatus 30 and data obtained by an operation of the terminal apparatus 30.

The communication interface 33 includes at least one interface for communication. The interface for communication is, for example, an interface corresponding to a mobile communication standard such as LTE, the 4G standard, or the 5G standard, an interface corresponding to a near field communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data for use in an operation of the terminal apparatus 30, and transmits data obtained by an operation of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation to input data for use in an operation of the terminal apparatus 30. The input interface 34, instead of being included in the terminal apparatus 30, may be connected to the terminal apparatus 30 as an external input device. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by an operation of the terminal apparatus 30. The output interface 35, instead of being included in the terminal apparatus 30, may be connected to the terminal apparatus 30 as an external output device. As the connection method, any technology such as USB, HDMI®, or Bluetooth® can be used.

The positioner 36 includes at least one GNSS receiver. The term “GNSS” is an abbreviation of global navigation satellite system. GNSS is, for example, GPS, QZSS, BeiDou, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the terminal apparatus 30.

The functions of the terminal apparatus 30 are realized by executing an arbitrary terminal program by a processor as the controller 31. In other words, the functions of the terminal apparatus 30 are realized by software. The terminal program causes a computer to execute operations of the terminal apparatus 30, to thereby cause the computer to function as the terminal apparatus 30. In other words, the computer executes operations of the terminal apparatus 30 according to the terminal program, to thereby function as the terminal apparatus 30.

Some or all of the functions of the terminal apparatus 30 may be realized by a programmable circuit or a dedicated circuit as the controller 31. That is, some or all of the functions of the terminal apparatus 30 may be realized by hardware.

Operations of the information providing system 10 according to the present embodiment will be described with reference to FIG. 4. These operations correspond to the information providing method according to the present embodiment.

In Step S101, the communication interface 23 of the information providing apparatus 20 communicates with the terminal apparatus 30, and receives destination data transmitted from the terminal apparatus 30. In the present embodiment, the destination data indicates the destination of the user 11 who is to be delivered to the destination by the vehicle 12. The destination data indicates the name, address, or location of the destination selected by the user 11. The location is indicated by, for example, two-dimensional coordinates or three-dimensional coordinates. The controller 21 of the information providing apparatus 20 acquires the destination data received by the communication interface 23.

The destination data may be transmitted to the information providing apparatus 20 through an arbitrary procedure. As one method, for example, the destination data is transmitted to the information providing apparatus 20 through the following procedure.

The controller 31 of the terminal apparatus 30 accepts an operation made by the user 11 to input the destination data, through the input interface 34 such as a touch screen. The controller 31 controls the communication interface 33 to transmit the input destination data. The communication interface 33 transmits the destination data to the information providing apparatus 20.

The destination data may be input to an in-vehicle device such as a car navigation device mounted on the vehicle 12, instead of the terminal apparatus 30, and may be transmitted to the information providing apparatus 20 from the in-vehicle device. Instead of the user 11, a driver of the vehicle 12 may perform the operation for inputting the destination data.

In Step S102, the controller 21 of the information providing apparatus 20 determines whether the arrival time slot in which the user 11 is to arrive at the destination is included either in a first time slot or in a second time slot that is later than the first time slot. When the arrival time slot is determined to be in the first time slot in Step S102, the controller 21 of the information providing apparatus 20 selects, in Step S103, a food-serving facility as the facility to be recommended to the user 11. When the arrival time slot is determined to be in the second time slot in Step S102, the controller 21 selects an accommodation facility as the facility to be recommended to the user 11 in Step S104. Specifically, the controller 21 predicts the arrival time at which the user 11 is to arrive at the destination, and determines the time slot including the predicted arrival time as the arrival time slot. When the arrival time slot is included in the first time slot, the processing of Step S103 is performed. When the arrival time slot is included in the second time slot, the processing of Step S104 is performed.

The arrival time may be predicted by any method. In the present embodiment, the controller 21 of the information providing apparatus 20 predicts the arrival time at which the user 11 is to arrive at the destination, based on the departure time at which the user 11 departs from a departure point and a distance or time required to travel from the departure point to the destination. Specifically, the controller 21 extracts, for example, positional data for the house of the user 11 from a database in which positional data for houses of one or more users of the information providing system 10 is registered in advance. The controller 21 then identifies the point indicated by the extracted positional data as the departure point for the user 11. The controller 21 predicts the arrival time at which the user 11 is to arrive at the destination, based on the distance from the identified departure point to the destination.

As an example, assume that the user 11 left home at 8:00 and is heading to a destination. The distance from the house of the user 11 to the destination is assumed as 300 km and the traveling speed of the user 11 is assumed as 50 km/h. The controller 21 calculates that it takes 6 hours from the house of the user 11, which is the departure point, to the destination. The controller 21 sets 8:00, which is the time at which the user 11 left home, as the departure time, and predicts the arrival time as 14:00 which is 6 hours after 8:00.

In the present embodiment, the first time slot is a time slot that includes 12:00, and the second time slot is a time slot that includes 24:00. The time slot may be set by any method. One conceivable method is to divide a day into daytime and nighttime. Specifically, the first time slot may be defined as a time slot from 6:00 to 18:00, and the second time slot may be defined as a time slot from 18:00 to 6:00 on the following day.

As an example, assume that the arrival time is predicted as 14:00 in Step S102. In this case, the controller 21 of the information providing apparatus 20 determines the first time slot including the arrival time as the arrival time slot. When the controller 21 has determined the arrival time slot as the first time slot, the processing of Step S103 is performed.

In Step S103, the controller 21 of the information providing apparatus 20 selects a food-serving facility as the facility to be recommended to the user 11. When selecting a food-serving facility, the controller 21 refers to the first profile data 51 indicating the preference of the user 11 for food and selects at least one of the plurality of food-serving facility candidates. The first profile data 51 indicates, for example, the genre of food ingredients or cooking preferred by the user 11, whether the user 11 prefers local meals, the dietary restrictions being made by the user 11, the food allergy of the user 11 to a specific food, and the budget desired by the user 11. For example, the controller 21 of the information providing apparatus 20 searches an arbitrary database in which a plurality of food-serving facilities are registered in advance, and selects, from among the plurality of food-serving facility candidates, at least one food-serving facility that most closely matches the preference of the user 11 for food indicated by the first profile data 51.

As an example, assume that the arrival time is predicted as 20:00 in Step S102. In this case, the controller 21 of the information providing apparatus 20 determines the second time slot including the arrival time as the arrival time slot. When the controller 21 determines the arrival time slot as the second time slot, the processing of Step S104 is performed.

In Step S104, the controller 21 of the information providing apparatus 20 selects an accommodation facility as the facility to be recommended to the user 11. When selecting an accommodation facility, the controller 21 refers to the second profile data 52 indicating preference of the user 11 for accommodation services and selects at least one of a plurality of accommodation facility candidates. The second profile data 52 indicates, for example, the room type, budget, or accommodation plan desired by the user 11, or the benefits or privileges to be provided to the user 11 by a particular accommodation facility. For example, the controller 21 of the information providing apparatus 20 searches an arbitrary database in which a plurality of accommodation facilities are registered in advance, and selects, from among the plurality of accommodation facility candidates, at least one accommodation facility that most closely matches the preference of the user 11 for accommodation services indicated by the second profile data 52.

In this manner, the controller 21 of the information providing apparatus 20 performs the processing from Step S101 to Step S104, to thereby select either one of a food-serving facility and an accommodation facility as the facility to be recommended to the user 11, according to the arrival time slot in which the user 11 is to arrive at the destination. When selecting a food-serving facility, the controller 21 refers to the first profile data 51 indicating the preference of the user 11 for food and selects at least one of a plurality of food-serving facility candidates. When selecting an accommodation facility, the controller 21 refers to the second profile data 52 indicating the preference of the user 11 for accommodation services and selects at least one of a plurality of accommodation facility candidates.

The processing of Step S105 is performed regardless of which of a food-serving facility and an accommodation facility has been selected by the controller 21 of the information providing apparatus 20.

In Step S105, the controller 21 of the information providing apparatus 20 transmits the facility data indicating the selected candidate to the terminal apparatus 30 via the communication interface 23. The facility data is data for identifying the selected facility. In the present embodiment, the facility data includes data indicating the name, location, route to the location, availability, and contact information of the facility. When the selected facility is a food-serving facility, the facility data may further include data indicating a menu list. When the selected facility is an accommodation facility, the facility data may further include data indicating an accommodation plan. The controller 21 controls the communication interface 23 to transmit the facility data. The communication interface 23 transmits the facility data to the terminal apparatus 30.

The controller 31 of the terminal apparatus 30 receives the facility data transmitted from the information providing apparatus 20 via the communication interface 33, and displays the facility data on the output interface 35 such as a display. The name, location, route to the location, availability, and contact information of the facility indicated by the facility data are displayed in text, for example, on the output interface 35.

According to the present embodiment, a facility suitable for the situation under which the user 11 arrives at the destination and the preference of the user 11 can be recommended to the user 11 in a timely manner.

In the present embodiment, the controller 21 of the information providing apparatus 20 further performs the following processing from Step S106 to Step S110, to thereby transmit, when the facility selected as the facility to be recommended to the user 11 is designated by the user 11 and the distance from the position of the user 11 to the designated facility is less than a first threshold, reservation data for reserving the designated facility or arrival data indicating the arrival of the user 11 via the communication interface 23, to a control apparatus provided in the designated facility. The controller 21 transmits the reservation data when the distance from the position of the user 11 to the designated facility is less than a first threshold and is equal to or greater than the second threshold that is smaller than the first threshold. The controller 21 transmits the arrival data when the distance from the position of the user 11 to the designated facility is less than the second threshold.

In Step S106, the controller 21 of the information providing apparatus 20 determines whether the facility indicated by the facility data presented to the user 11 in Step S105 has been designated by the user 11. When an operation for designating the facility is performed by the user 11 on the terminal apparatus 30, the terminal apparatus 30 transmits designation data indicating that the facility is designated by the user 11 to the information providing apparatus 20.

The designation data may be transmitted to the information providing apparatus 20 through an arbitrary procedure. As one method, for example, the designation data is transmitted to the information providing apparatus 20 through the following procedure.

The controller 31 of the terminal apparatus 30 accepts an operation made by the user 11 to designate the selected facility, via the input interface 34 such as a touch screen. The operation to be made by the user 11 for designating a facility may be performed by any method. As one method, for example, the user 11 may perform a GUI operation such as pressing a “designate” button that is displayed in association with the facility data displayed in text on the output interface 35. The term “GUI” is an abbreviation of graphical user interface.

As a modification of the present embodiment, the operation made by the user 11 to designate a facility may include an operation made by the user 11 to designate at least one of the menus indicated by the facility data when the selected facility is a food-serving facility. Alternatively, when the selected facility is an accommodation facility, the operation made by the user 11 to designate a facility may include an operation made by the user 11 to designate at least one of the accommodation plans indicated by the facility data.

The controller 31 of the terminal apparatus 30 generates designation data indicating that the facility has been designated by the user 11. The controller 31 controls the communication interface 33 to transmit the designation data. The communication interface 33 transmits the designation data to the information providing apparatus 20. The controller 21 of the information providing apparatus 20 receives the designation data transmitted from the communication interface 33 of the terminal apparatus 30, via the communication interface 23. The controller 21 of the information providing apparatus 20 acquires the designation data received via the communication interface 23. Then, the processing of Step S107 is performed. When the user 11 has not performed the operation for designating the facility, the flow of FIG. 4 ends.

In Step S107, the controller 21 of the information providing apparatus 20 determines whether the distance from the position of the user 11 to the specified facility is less than a first threshold. The controller 21 calculates the distance from the position of the user 11 indicated by the positional data acquired by the positioner 36 of the terminal apparatus 30 to the designated facility, and compares the calculated distance with the first threshold. When the calculated distance is less than the first threshold, the processing of Step S108 is performed. When the calculated distance is not less than the first threshold, the processing of Step S107 is repeatedly performed until the distance from the position of the user 11 to the designated facility becomes less than the first threshold.

In Step S108, the controller 21 of the information providing apparatus 20 transmits reservation data for reserving the facility designated by the user 11 to another control apparatus installed in the designated facility via the communication interface 23. The control apparatus is, for example, a server or a terminal. In the present embodiment, the control apparatus is a reservation management server configured to manage reservation for prospective users of the facility. The control apparatus, instead of being configured as a server installed in the facility, may be configured as a terminal installed in the facility and used by the employees of the facility.

According to the present embodiment, when the user 11 approaches a facility designated by the user 11 while traveling, the facility is automatically reserved, so that the user 11 does not need to directly contact the facility to make a reservation. Thus, the convenience of the information providing system 10 is improved.

In Step S109, the controller 21 of the information providing apparatus 20 determines whether the distance from the position of the user 11 to the designated facility is less than a second threshold that is smaller than the first threshold. The controller 21 calculates the distance from the position of the user 11 indicated by the positional data acquired by the positioner 36 of the terminal apparatus 30 to the designated facility, and compares the calculated distance with the second threshold. When the calculated distance is less than the second threshold, the processing of Step S110 is performed. When the calculated distance is not less than the second threshold value, the processing of Step S109 is repeatedly performed until the distance from the position of the user 11 to the specified facility becomes less than the second threshold.

In Step S110, the controller 21 of the information providing apparatus 20 transmits arrival data notifying the arrival of the user 11 to the facility designated by the user 11, to the control apparatus of the designated facility via the communication interface 23.

According to the present embodiment, when the user 11 further approaches the facility designated by the user 11 while traveling, the arrival of the user 11 to the facility is automatically notified to the designated facility, so that the facility will be able to provide services such as welcoming the user 11 upon arrival. Accordingly, the convenience of the information providing system 10 and the quality of the customer service at the facility are improved.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

As a modification of the present embodiment, the controller 21 of the information providing apparatus 20 may acquire, in Step S102, positional data indicating the position of the user 11, instead of identifying the point where the house of the user 11 is located as the departure point. The controller 21 calculates the distance from the position indicated by the acquired positional data to the destination. The controller 21 calculates time required to travel from the position of the user 11 indicated by the positional data to the destination, based on the time at which the positional data for the user 11 was acquired and the calculated distance.

The positional data indicating the position of the user 11 may be acquired by any method. In the present modification, the controller 21 of the information providing apparatus 20 acquires the positional data indicating the position measured by the positioner 36 of the terminal apparatus 30 held by the user 11. The controller 21 calculates the distance from the position of the user 11 indicated by the positional data to the destination. The controller 21 predicts the arrival time at which the user 11 is to arrive at the destination, based on the time at which the positional data was acquired and the calculated distance. The controller 21 determines the time slot including the predicted arrival time as the arrival time slot.

In the present modification, assume that the user 11 is traveling toward the destination. Assume that the positional data was acquired at 10:00. Assume that the distance from the position of the user 11 indicated by the positional data to the destination is 200 km, and the traveling speed of the user 11 is 50 km/h. Therefore, the controller 21 calculates the time required to travel to the destination as 4 hours. The controller 21 predicts the arrival time to be 14:00, which is 4 hours after 10:00 which is the time at which the positional data for the user 11 was acquired. The controller 21 determines the first time slot which is the time slot including 14:00, as the arrival time slot.

According to the present modification, even if the user 11 is traveling, the arrival time slot can still be determined. For example, even if the user 11 is caught in a traffic congestion or other event while traveling and the traveling speed is reduced, the arrival time can still be predicted with high accuracy, so that the arrival time slot can be determined more accurately. Thus, a facility more suitable for the situation under which the user 11 arrives at the destination can be selected as the facility to be recommended to the user 11.

As a modification of the present embodiment, the controller 21 of the information providing apparatus 20 may further refer to, in selecting a facility to be recommended to the user 11 in Step S103 or Step S104, the positional data for the vehicle 12 carrying the user 11. The positional data for the vehicle 12 may be obtained by any method. As one method, for example, the controller 21 of the information providing apparatus 20 acquires the positional data indicating the position measured by the positioner 36 of the terminal apparatus 30 mounted on the vehicle 12 as an in-vehicle device such as a car navigation device, as the positional data indicating the position of the vehicle 12.

In the present modification, the facility to be recommended to the user 11 is selected based on the positional data for the vehicle 12, as well as the first profile data 51 and the second profile data 52. Specifically, the controller 21 selects, from among a plurality of candidates, a facility with the closest distance to the position of the vehicle 12 indicated by the positional data for the vehicle 12, as the facility to be recommended to the user 11. Therefore, the present modification enables to select a facility more suitable for the situation under which the user 11 arrives at the destination as the facility to be recommended to the user 11.

As a modification of the present embodiment, the controller 21 of the information providing apparatus 20 may further refer to, in selecting a facility to be recommended to the user 11 in Step S103 or Step S104, data indicating the travel history of the vehicle 12 carrying the user 11. The data indicating the travel history of the vehicle 12 may be acquired by any method. As one method, the controller 21 acquires, for example, travel data recorded in an on-board device such as a car navigation device or a drive recorder mounted on the vehicle 12.

In the present modification, the facility to be recommended to the user 11 is selected based on the travel history of the vehicle 12 carrying the user 11, as well as the first profile data 51 and the second profile data 52. Specifically, the controller 21 analyzes the travel history of the vehicle 12, and identifies a facility where the user 11 has visited frequently and a time slot in which the user 11 has visited the facility, to thereby predict, for each time slot, a facility that is highly likely to be visited by the user 11. The controller 21 selects, from among a plurality of candidates, a facility that is highly likely to be visited by the user 11 as the facility to be recommended to the user 11. Therefore, the present modification enables to select a facility more suitable for the situation under which the user 11 arrives at the destination as the facility to be recommended to the user 11.

As a modification of the present embodiment, the controller 21 of the information providing apparatus 20 may further refer to, in selecting a facility to be recommended to the user 11 in Step S103 or Step S104, data indicating a search history in which the user 11 has searched for accommodation facilities or food-serving facilities. The data indicating the search history in which the user 11 has searched for accommodation facilities or food-serving facilities may be acquired by any method. As one method, the controller 21 acquires, for example, from the terminal apparatus 30, data indicating a search history in which the user 11 has searched for accommodation facilities or food-serving facilities, stored in the memory 32 of the terminal apparatus 30.

In the present modification, the facility to be recommended to the user 11 is selected based on the search history of the user 11, as well as the first profile data 51 and the second profile data 52. Specifically, the controller 21 analyzes the search history of the user 11 and identifies the facility retrieved by the user 11 and the time slot in which the facility is retrieved, to thereby predict the facility that is highly likely to be preferred by the user 11 for each time slot. The controller 21 selects, from among a plurality of candidates, a facility that is most likely to be preferred by the user 11 in the arrival time slot, as the facility to be recommended to the user 11. Therefore, the present modification enables to select a facility more suitable for the situation under which the user 11 arrives at the destination, as the facility recommended to the user 11.

As a modification of the present embodiment, the controller 21 of the information providing apparatus 20 may further refer to, in selecting a facility to be recommended to the user 11 in Step S103 or Step S104, data indicating the number of occupants on the vehicle 12 carrying the user 11. The data indicating the number of occupants on the vehicle 12 may be obtained by any method. As one method, for example, the controller 21 acquires, as the data indicating the number of occupants on the vehicle 12, an image obtained by imaging the vehicle by an imaging sensor such as an on-board camera mounted on the vehicle 12, and analyzes the image, to thereby determine the number of occupants on the vehicle 12. The controller 21 determines the number of people appearing in the acquired image, as the number of occupants on the vehicle 12.

In the present modification, the facility to be recommended to the user 11 is selected based on the number of occupants on the vehicle 12 as well as the first profile data 51 and the second profile data 52. Specifically, the controller 21 selects, from among a plurality of candidates, a facility capable of accommodating all the occupants on the vehicle 12, as the facility to be recommended to the user 11. The present modification enables to select a facility more suitable for the situation under which the user 11 arrives at the destination as the facility to be recommended to the user 11.

As a modification of the present embodiment, the controller 21 of the information providing apparatus 20 may further refer to, in selecting a facility to be recommended to the user 11 in Step S103 or Step S104, biometric data for the user 11. The biometric data includes data indicating the heart rate, pulse rate, respiration rate, or blood pressure of the user 11. The biometric data may be acquired by any method. As one example, the controller 21 may acquire, as the biometric data for the user 11, data from a biological sensor worn by the user 11, the data indicating the heart rate, pulse rate, respiration rate, or blood pressure measured by the biological sensor, and analyze the acquired biometric data, to thereby determine the physical condition of the user 11. For example, when selecting a food-serving facility in Step S103, the controller 21 refers to the biometric data for the user 11, determines that the user 11 is hungry when the blood pressure indicated by the biometric data is low, and selects a facility that provides a volumetric cooking from among the plurality of food-serving candidates.

In the present modification, the facility recommended to the user 11 is selected based on the biometric data of the user 11, as well as the first profile data 51 and the second profile data 52. Specifically, the controller 21 selects, from among a plurality of candidates, a facility suitable for the physical condition of the user 11 as the facility to be recommended to the user 11. The present modification enables to select a facility more suitable for the situation under which the user 11 arrives at the destination, as the facility to be recommended to the user 11.

As a modification of the present embodiment, the controller 21 of the information providing apparatus 20 may further refer to, in selecting a facility to be recommended to the user 11 in Step S103 or Step S104, data indicating the weather around the destination in the arrival time slot. The data indicating the weather around the destination in the arrival time slot may be acquired by any method. As one method, for example, the controller 21 acquires weather data from a commercial database indicating weather conditions, and analyzes the acquired weather data to predict the weather around the destination in the arrival time slot. The controller 21 acquires data indicating the predicted weather as the data indicating the weather around the destination in the arrival time slot.

In the present modification, the facility to be recommended to the user 11 is selected based on the weather around the destination in the arrival time slot, as well as the first profile data 51 and the second profile data 52. For example, when the controller 21 of the information providing apparatus 20 is selecting a food-serving facility in Step S103, assume that the first profile data 51 indicating the preference of the user 11 for food indicates that the user 11 prefers outdoor cooking. Further, assume that the weather around the destination in the arrival time slot is predicted to be rain. In this case, the controller 21 selects, from among the plurality of food-serving candidates, an indoor barbeque facility as the facility to be recommended to the user 11. Thus, a facility more suitable for the situation under which the user 11 arrives at the destination can be selected as the facility recommended to the user 11.

1. An information providing apparatus, comprising:
a communication interface configured to communicate with a terminal apparatus; and
a controller configured to:
select either one of a food-serving facility and an accommodation facility as a facility to be recommended to a user, according to an arrival time slot in which the user is to arrive at a destination; refer to, when selecting the food-serving facility, first profile data indicating preference of the user for food to select at least one of a plurality of food-serving facility candidates; and refer to, when selecting the accommodation facility, second profile data indicating preference of the user for accommodation services to select at least one of a plurality of accommodation facility candidates; and
transmit, regardless of which of the food-serving facility and the accommodation facility has been selected, facility data indicating a selected candidate, to the terminal apparatus via the communication interface.

2. The information providing apparatus according to claim 1, wherein the controller selects the food-serving facility when the arrival time slot is a first time slot, and selects the accommodation facility when the arrival time slot is a second time slot that is later than the first time slot, as the facility to be recommended to the user.

3. The information providing apparatus according to claim 2, wherein the first time slot is a time slot including 12:00 and the second time slot is a time slot including 24:00.

4. The information providing apparatus according to claim 1, wherein the controller predicts an arrival time at which the user is to arrive at the destination, based on a departure time at which the user departs from a departure point and a distance or time required to travel from the departure point to the destination, and determines a time slot including the predicted arrival time as the arrival time slot.

5. The information providing apparatus according to claim 1, wherein the controller acquires positional data indicating a position of the user, predicts an arrival time at which the user is to arrive at the destination based on a time at which the positional data was acquired and a distance or time required to travel from the position indicated by the positional data to the destination, and determines a time slot including the predicted arrival time as the arrival time slot.

6. The information providing apparatus according to claim 1, wherein the controller further refers to, in selecting the facility to be recommended to the user, positional data for a vehicle carrying the user.

7. The information providing apparatus according to claim 1, wherein the controller further refers to, in selecting the facility to be recommended to the user, data indicating a travel history of a vehicle carrying the user.

8. The information providing apparatus according to claim 1, wherein the controller further refers to, in selecting the facility to be recommended to the user, data indicating a search history in which the user searched for food-serving facilities or accommodation facilities.

9. The information providing apparatus according to claim 1, wherein the controller further refers to, in selecting the facility to be recommended to the user, data indicating a number of occupants on a vehicle carrying the user.

10. The information providing apparatus according to claim 1, wherein the controller further refers to, in selecting the facility to be recommended to the user, biometric data for the user.

11. The information providing apparatus according to claim 1, wherein the controller further refers to, in selecting the facility to be recommended to the user, data indicating weather around the destination in the arrival time slot.

12. The information providing apparatus according to claim 1, wherein, when the facility selected as the facility to be recommended to the user is designated by the user, the controller transmits reservation data for reserving the designated facility or arrival data for notifying arrival of the user to a control apparatus installed in the designated facility via the communication interface when a distance from a position of the user to the designated facility is less than a first threshold.

13. The information providing apparatus according to claim 12, wherein the controller transmits the reservation data when the distance from the position of the user to the designated facility is less than the first threshold and equal to or greater than a second threshold smaller than the first threshold, and transmits the arrival data when the distance from the position of the user to the designated facility is less than the second threshold.

14. An information providing system comprising:
the information providing apparatus according to claim 1; and
a terminal apparatus configured to receive the facility data from the information providing apparatus.

15. The information providing system according to claim 14, wherein the terminal apparatus is provided in a vehicle.

16. A non-transitory computer readable medium storing an information providing program for causing a computer to execute operations, the operations comprising:
receiving, from a terminal apparatus that has accepted an operation made by a user to select a destination, data indicating the destination;
selecting either one of a food-serving facility and an accommodation facility as a facility to be recommended to the user, according to an arrival time slot in which the user is to arrive at the destination;
referring to, when selecting the food-serving facility, first profile data indicating preference of the user for food to select at least one of a plurality of food-serving facility candidates;
referring to, when selecting the accommodation facility, second profile data indicating preference of the user for accommodation services to select at least one of a plurality of accommodation facility candidates; and
transmitting, regardless of which of the food-serving facility and the accommodation facility has been selected, facility data indicating a selected candidate, to the terminal apparatus.

17. The non-transitory computer readable medium according to claim 16, wherein the selecting of the facility to be recommended to the user comprises selecting the food-serving facility when the arrival time slot is a first time slot, and selecting the accommodation facility when the arrival time slot is a second time slot that is later than the first time slot.

18. An information providing method, comprising:
accepting, by a terminal apparatus, an operation made by a user to input a destination;
transmitting, by the terminal apparatus, destination data indicating the destination input by the user to an information providing apparatus;
selecting, by the information providing apparatus, either one of a food-serving facility and an accommodation facility as a facility to be recommended to the user, according to an arrival time slot in which the user is to arrive at the destination, referring to, when selecting the food-serving facility, first profile data indicating preference of the user for food to select at least one of a plurality of food-serving facility candidates, and referring to, when selecting the accommodation facility, second profile data indicating preference of the user for accommodation services to select at least one of a plurality of accommodation facility candidates;
transmitting, regardless of which of the food-serving facility and the accommodation facility has been selected, facility data indicating a selected candidate, to the terminal apparatus;
receiving, by the terminal apparatus, the facility data from the information providing apparatus; and
presenting, by the terminal apparatus, the facility data to the user.

19. The information providing method according to claim 18, wherein the selecting of the facility to be recommended to the user comprises selecting the food-serving facility when the arrival time slot is a first time slot and selecting the accommodation facility when the arrival time slot is a second time slot that is later than the first time slot.

20. The information providing method according to claim 18, further comprising: predicting, by the information providing apparatus, an arrival time at which the user is to arrive at the destination based on a departure time at which the user departs from a departure point and a distance or time required to travel from the departure point to the destination, to determine, as the arrival time slot, a time slot including the predicted arrival time.
